(19) United States
(12) Patent Application Publication
(10) Pub. No.: US 2009/0290899 A1
(43) Pub. Date: Nov. 26, 2009

(54) IMAGE FORMING APPARATUS

(75) Inventors: Nobuhiko OKANO, Tokyo (JP); Hirotaka KABASHIMA, Tokyo (JP); Shinichi TSUKAMURA, Uenohara-shi (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/470,107

(22) Filed: May 21, 2009

(30) Foreign Application Priority Data
May 21, 2008 (JP) 2008-132650

(51) Int. Cl. G03G 15/16

(52) U.S. Cl. 399/101

(57) ABSTRACT

Disclosed is an image forming apparatus comprising: a developing device to house a toner and to form a toner image on an image carrier; a transfer belt to transfer the toner image formed on the image carrier to a sheet, the transfer belt comprising an elastic layer; and a blade to remove the toner remaining on the transfer belt after the toner image has been transferred, the blade being in contact with the transfer belt, wherein the transfer belt and the blade are configured so that a stiffness of the transfer belt is larger than a stiffness of the blade, in a temperature range which is no higher than a glass transition temperature of the toner.

### BACKGROUND OF THE INVENTION

1. Field of the Invention

The present invention relates to an image forming apparatus.

2. Description of Related Art

In an image forming apparatus using an electrophotographic method, a toner image is formed on an image carrier such as a photoconductive drum, and the like, so as to transfer the formed toner image on a sheet through a transfer belt. In such image forming apparatus, a blade is made in contact with the transfer belt at a downstream portion in the rotation direction so as to remove the toner remaining on the transfer belt, after the toner image has been transferred.

In many cases, a base layer of the transfer belt is an elastic layer which is formed by a rubber, and the like. When the stiffness of the transfer belt is smaller than that of the blade, the surface of the transfer belt is depressed by a contacting pressure of the blade. Thus, a state in which the blade is trapped by the depression, which is referred to as a blade flection, is likely to be generated. In order to solve this problem, a technique in which the stiffness of the transfer belt surface is configured to be larger than that of the blade so as to prevent the blade flection, is disclosed (see for example, Japanese Patent Application Laid-open Publication No. 2003-248379).

However, even when the stiffness of the transfer belt is configured to be larger than that of the blade at initial phases of the usage or of the installation, the blade flection may be generated depending on the usage timing or on the installation environment thereof.

### SUMMARY OF THE INVENTION

One of the objects of the present invention is to prevent the generation of the blade flection, regardless of a long-term usage or various usage environments of the image forming apparatus.

To achieve the above object, an information forming apparatus reflecting one aspect of the present invention, comprises:

a developing device to house a toner and to form a toner image on an image carrier;

a transfer belt to transfer the toner image formed on the image carrier to a sheet, the transfer belt comprising an elastic layer; and

a blade to remove the toner remaining on the transfer belt after the toner image has been transferred, the blade being in contact with the transfer belt, wherein

the transfer belt and the blade are configured so that a stiffness of the transfer belt is larger than a stiffness of the blade, in a temperature range which is no higher than a glass transition temperature of the toner.

To achieve the above object, an information forming apparatus reflecting another aspect of the present invention, comprises:

a developing device to house a toner and to form a toner image on an image carrier;

a transfer roller to transfer the toner image formed on the image carrier to a sheet, the transfer roller comprising an elastic layer; and

a blade to remove the toner remaining on the transfer roller after the toner image has been transferred, the blade being in contact with the transfer roller, wherein

the transfer roller and the blade are configured so that a stiffness of the transfer roller is larger than a stiffness of the blade, in a temperature range which is no higher than a glass transition temperature of the toner.

### BRIEF DESCRIPTION OF THE DRAWINGS

These and other objects, advantages and features of the present invention will become more fully understood from the detailed description given hereinbelow and the appended drawings, and thus are not intended as a definition of the limits of the present invention, and wherein:

FIG. 1 is a diagram showing an example of an image forming apparatus comprising a transfer/conveying belt;

FIG. 2 is an enlarged diagram of a transfer unit and a cleaning device shown in FIG. 1;

FIG. 3 is a partially enlarged cross-sectional diagram of the transfer/conveying belt shown in FIG. 2;

FIG. 4A is a diagram showing a state of a transfer/conveying belt at the time of the cleaning in a case where a stiffness of the transfer/conveying belt is smaller than that of a blade;

FIG. 4B is a diagram showing a state of the transfer/conveying belt at the time of the cleaning in a case where the stiffness of the transfer/conveying belt is larger than that of the blade;

FIG. 5 is a diagram showing a relationship between the stiffness and the temperature of a given transfer belt and a blade;

FIG. 6 is a diagram showing an example of an image forming apparatus comprising an intermediate transfer belt and a transfer roller; and

FIG. 7 is a diagram showing a stiffness-temperature characteristic of the blade and the transfer/conveying belt used in an example and in a comparative example.

### DETAILED DESCRIPTION OF THE PREFERRED EMBODIMENT

Hereinbelow, an embodiment of an image forming apparatus according to the present invention is described with reference to the drawings.

In the present embodiment, an example of the image forming apparatus using a transfer/conveying belt as a transfer belt, in which the stiffness of the transfer/conveying belt is configured to be larger than that of the blade, is described. Here, a toner image on an image carrier is transferred on a sheet while the sheet is being conveyed, by the transfer/conveying belt.

First, the configuration is described.

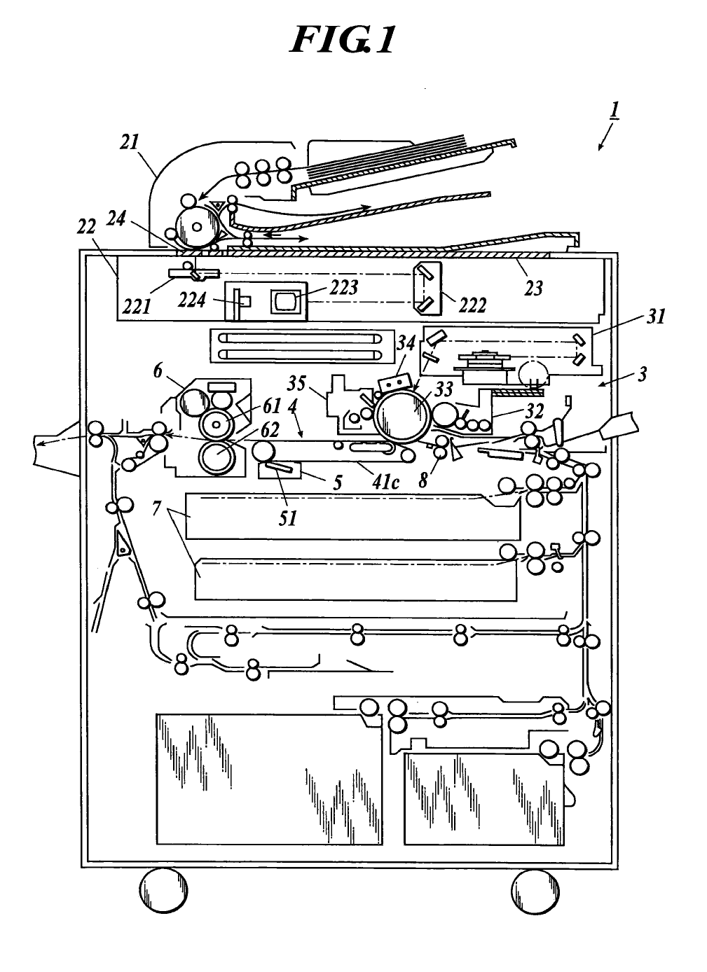

FIG. 1 shows the configuration of an image forming apparatus 1 according to the present embodiment.

The image forming apparatus 1 is a monochrome image forming apparatus in which toners of a single color is used.

As shown in FIG. 1, a document automatic feeding device 21 is provided in the main body upper portion of the image forming apparatus 1. The document automatic feeding device 21 comprises a plurality of conveying rollers so as to convey a document placed on a platen to a slit glass 24 which is a reading surface of an image reading section 22.

The main body of the image forming apparatus 1 comprises the image reading section 22, an image forming unit 3, a transfer unit 4, a cleaning device 5, a fixing device 6, a feeding unit 7, and the like.

The image reading section 22 comprises an exposing/scanning part 221 which has a light source and a miller, a V-shaped miller part 222 in which two millers are placed in a V-shape, a lens 223, a charge-coupled device (CCD) image sensor 224. When a document is conveyed by the document automatic feeding device 21, the exposing/scanning part 221 moves to an initial position which is located at a lower side of the slit glass 24. The exposing/scanning part 221 irradiates a scanning light to the document which is conveyed to the slit glass 24, in a state of being suspended at the initial position. On the other hand, when the document is placed on a platen glass 23, the exposing/scanning part 221 and the V-shaped miller part 222 move so as to irradiate the scanning light to the document. When the reflection light from the document is received by the exposing/scanning part 221, the reflection light is led to the CCD image sensor 224 through the V-shaped miller part 222 and the lens 223. An image signal (an analog signal) is generated by a photoelectric conversion in the CCD image sensor 224.

The image signal is digitized by a signal processing section (not shown) and is performed with various signal processing if necessary, so as to be temporarily stored in a memory. Subsequently, the stored image signal is read from the memory so that the read memory is output to the image forming unit 3.

The image forming unit 3 comprises an exposing device 31, a developing device 32, a photoconductive drum 33 which is the image carrier, a charging device 34, and a cleaning device 35. When an image is to be formed, the charging device 34 charges the photoconductive drum 33, the exposing device 31 irradiates a laser light on the photoconductive drum 33 based on the image signal, so that an electrostatic latent image is formed. The developing device 32 houses a toner so as to perform the developing by using the toner, thus forms a toner image on the photoconductive drum 33.

On the other hand, the feeding unit 7 houses sheets to supply the housed sheets. The sheets supplied from the feeding unit 7 are conveyed to a resist roller 8, and is conveyed to a position which is between the transfer unit 4 and the photoconductive drum 33 by the resist roller 8. The toner image is transferred to the sheet by the transfer unit 4 and by the photoconductive drum 33, while the entering timing of the sheet to the transfer position is measured so as to be synchronized with the movement of the toner image caused by the rotation of the photoconductive drum 33, by the resist roller 8.

The transfer unit 4 transfers the toner image which is formed on the photoconductive drum 33, to the sheet which is conveyed thereto by the resist roller 8, and subsequently, conveys the sheet to the fixing device 6.

The fixing device 6 performs heating and pressurization for the conveyed sheet by a fixing roller 61 which comprises a heat source, and by a pressurizing roller 62, so as to perform fixing processing. The sheet which has been performed with the fixing processing is discharged onto a tray which is provided in an external section of the image forming apparatus 1.

After the toner image is transferred to the sheet, the cleaning device 35 performs a removal of the toner remaining on the photoconductive drum 33, and the cleaning device 5 performs a removal of the toner remaining on the transfer/conveying belt of the transfer unit 4.

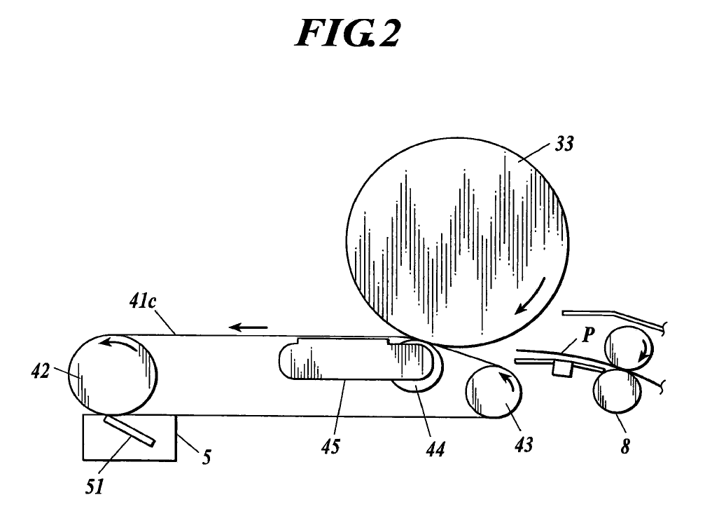

Next, further description is given to the transfer unit 4 and the cleaning device 5, with reference to FIG. 2. Incidentally, the arrows shown in FIG. 2 indicate the rotation direction and the moving direction of each section.

As shown in FIG. 2, the transfer unit 4 comprises a transfer/conveying belt 41c, a driving roller 42, a driven roller 43, a backup roller 44, a supporting frame 45, and the like. The transfer/conveying belt 41c is provided in a state of being stretched by the three rollers of the driving roller 42, the driven roller 43, and the backup roller 44, so as to be revolved.

The backup roller 44 is pressed onto the photoconductive drum 33 through the transfer/conveying belt 41c. The supporting frame 45 supports the backup roller 44, and moves the backup roller 44 in a vertical direction, so as to adjust the pressing strength of the backup roller 44 with respect to the photoconductive drum 33. When the sheet is conveyed to the position between the photoconductive drum 33 and the transfer/conveying belt 41c by the resist roller 8, the toner image on the photoconductive drum 33 is transferred to the conveyed sheet by the pressing of the backup roller 44 on the transfer/conveying belt 41c. Subsequently, the sheet is conveyed to the fixing device 6 in accordance with the rotation direction of the transfer/conveying belt 41c.

The cleaning device 5 comprises a blade 51. As the blade 51, a urethane rubber, and the like, may be used.

The blade 51 is provided so as to be in contact with the transfer/conveying belt 41c. Further, the blade 51 is provided so as to face the driving roller 42 through the transfer/conveying belt 41c, at a further downstream position in the rotation direction of the driving roller 42 than the transfer position of the toner image to the sheet. After the toner image has been transferred, in a case where the remaining toner exists on the transfer/conveying belt 41c, the remaining toner is scraped off by the blade 51 which is in contact with the transfer/conveying belt 41c, so as to be removed. Incidentally, the reason why the blade 51 is provided at a position where a facing member which is the driving roller 42 exists is as follows. That is, since the transfer/conveying belt 41c has a belt-like structure, the transfer/conveying belt 41c deflects when being added with the contacting pressure by the blade 51, in a case where the facing member such as the driving roller 42, and the like, formed by a metal, and the like, which is a material having a large stiffness, thereby resulting in difficulty of removing the remaining toner by the blade 51 which is in contact with the transfer/conveying belt 41c.

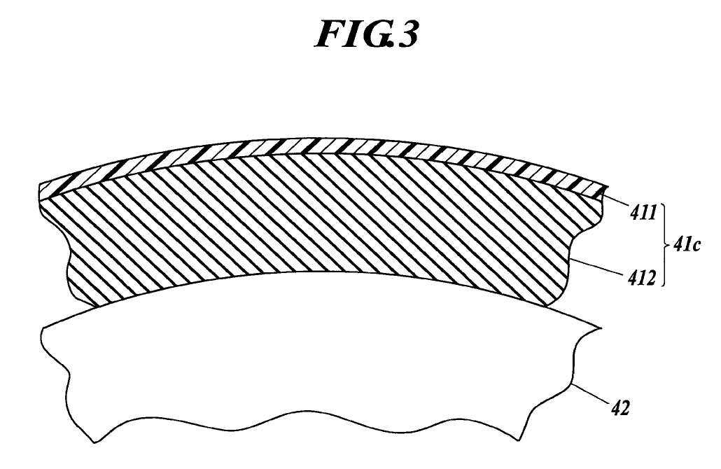

As shown in FIG. 3, the transfer/conveying belt 41c comprises an elastic layer 412 as the base layer. As the elastic layer 412, a chloroprene rubber (CR), a substance in which the CR is mixed with a white carbon, and the like, may be used. Further, since a significant amount of friction is to be caused by the blade and the mere elastic layer 412, which results in difficulty of performing the cleaning by the blade 51, a coating layer 411 is formed on a surface layer of the elastic layer 412. As the coating layer 411, a urethane resin containing fluorine, and the like, may be used. In consideration of the separation of the sheet from the photoconductive drum 33, the thickness of the coating layer 411 is preferably no more than 5 μm, and is more preferably no more than 3 μm.

By configuring the transfer/conveying belt 41c so that the stiffness thereof is larger than that of the blade 51, the generation of the blade flection can be prevented. However, it is discovered that there may be a case where the stiffness may be reversed, and that the reverse is dependent on a temperature, through experiments regarding various transfer belts and blades.

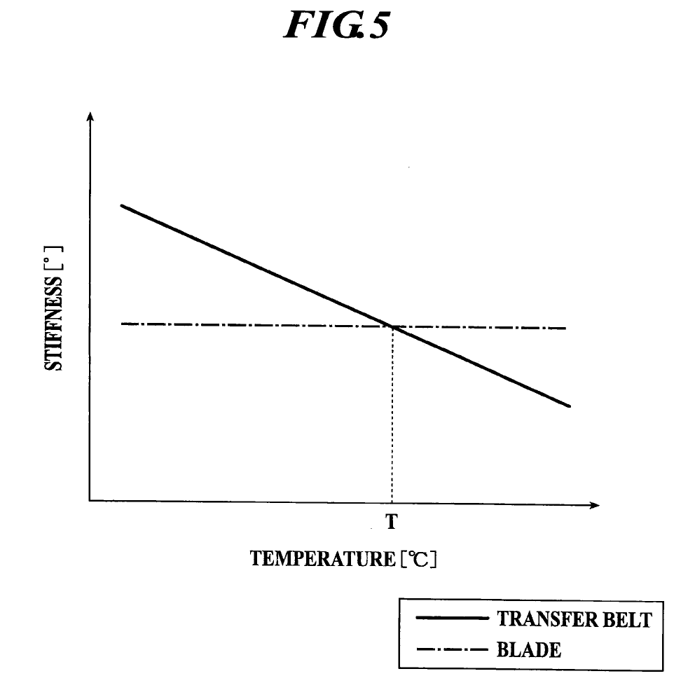

FIG. 5 is a diagram showing the relationship between the stiffness and the temperature of a given transfer belt and a blade. As shown in FIG. 5, it can be found out that the stiffness of the transfer belt is larger than that of the blade until a certain temperature T° C., however, the relationship of the stiffness is reversed in a case exceeding the temperature T° C.

Accordingly, in the present embodiment, the transfer/conveying belt 41c is configured so that the stiffness (JIS-A) thereof is greater than that of the blade 51 in a temperature range which is no higher than a glass transition temperature of the toner housed in the developing device 32. The stiffness of the transfer/conveying belt 41c is defined as the stiffness of a portion at which the transfer/conveying belt 41c is in contact with the blade 51. The stiffness of the transfer/conveying belt 41c and of the blade 51 may preferably have a difference of no less than 1°, and may more preferably have a difference of no less than 2°, in the temperature range which is no higher than the glass transition temperature of the toner.

The reason why the stiffness of the transfer/conveying belt 41c is made to be larger than that of the blade 51, not only at a certain temperature, but also in a whole temperature range which is no higher than the glass transition temperature of the toner is as follows. That is, the internal temperature of the image forming apparatus 1, specifically the temperature in the vicinity of the blade 51 and of the transfer/conveying belt 41c, may be raised according to the surrounding environment and the operational state of the image forming apparatus 1. On the other hand, the stiffness relationship between the transfer/conveying belt 41c and the blade 51 does not always have to be maintained at every high-temperature state. In a case where a certain temperature exceeds the glass transition temperature of the toner, the toner housed in the developing device 32 melts, which makes the image formation itself impossible. That is to say, the cleaning function is required to be maintained only while the image formation is possible. Thus, the stiffness of the transfer/conveying belt 41c is configured to be larger than that of the blade 51, only in the temperature range which is no higher than the glass transition temperature.

The thickness of the coating layer 411 of the transfer/conveying belt 41c is small, so as to be no more than 5 μm as described above. However, in such condition, the stiffness of the elastic layer 412 which is the base layer is to greatly influence the stiffness of the transfer/conveying belt 41c at the portion at which the transfer/conveying belt 41c is in contact with the blade 51. Accordingly, the material of the elastic layer 412 is selected based on the characteristics of the stiffness of the elastic layer 412 and the temperature (hereinbelow referred to as a stiffness-temperature characteristics), thereby the stiffness can be controlled.

For example, when the glass transition temperature of the toner is 60° C., a urethane rubber whose stiffness is approximately 74° at a temperature which is no higher than an internal temperature of 60° C. inside of the image forming apparatus 1 is adopted as the blade 51. Further, a material whose stiffness is no less than 75° at a temperature which is no higher than an internal temperature of 60° C. is selected for the elastic layer 412 of the transfer/conveying belt 41c.

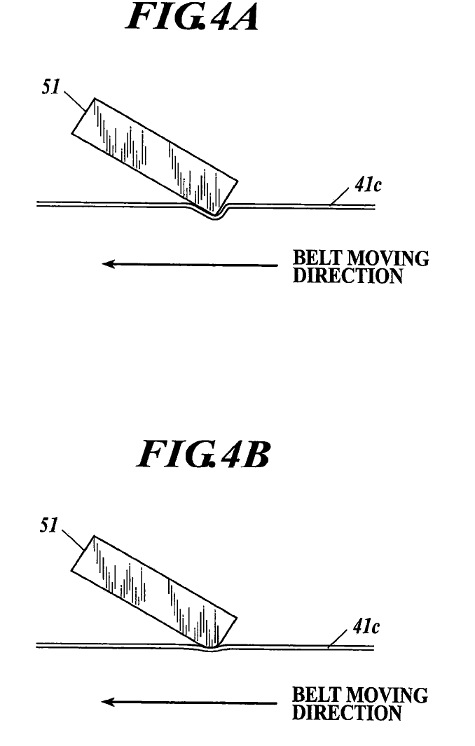

As shown in FIG. 4A, in a case where the stiffness of the transfer/conveying belt 41c is smaller than that of the blade 51, the transfer/conveying belt 41c side is depressed in the thickness direction thereof by the contacting pressure of the blade 51, thereby the contacting area of the transfer/conveying belt 41c with the blade 51 increases. As a result, the friction caused by the transfer/conveying belt 41c and the blade 51 is increased, and the tip of the blade 51 is trapped by the transfer/conveying belt 41c, which results in the generation of the blade flection.

On the other hand, according to the present embodiment, the transfer/conveying belt 41c is configured so that the stiffness thereof is larger than that of the blade 51, in the temperature range which is no higher than the glass transition temperature of the toner. Accordingly, as shown in FIG. 4B, the depression of the transfer/conveying belt 41c in the thickness direction is of a small degree, and the tip of the blade 51 is reversely depressed and deformed by the contacting pressure. The friction caused by the transfer/conveying belt 41c and the blade 51 is of a small degree, and the blade 51 is to slide on the moving transfer/conveying belt 41c, thereby the generation of the blade flection can be prevented.

Incidentally, the above described embodiment is a preferable example of the present invention and the present invention is not limited to this.

For example, the transfer belt is not limited to the above described transfer/conveying belt 41c, but may also be used for an intermediate transfer belt. The intermediate transfer belt is a transfer belt to transfer a toner image on a sheet. However, unlike the transfer/conveying belt which transfers the toner image directly onto the sheet, the intermediate transfer belt transfers the toner image thereupon, and subsequently the transferred toner image is further transferred onto the sheet from the intermediate transfer belt.

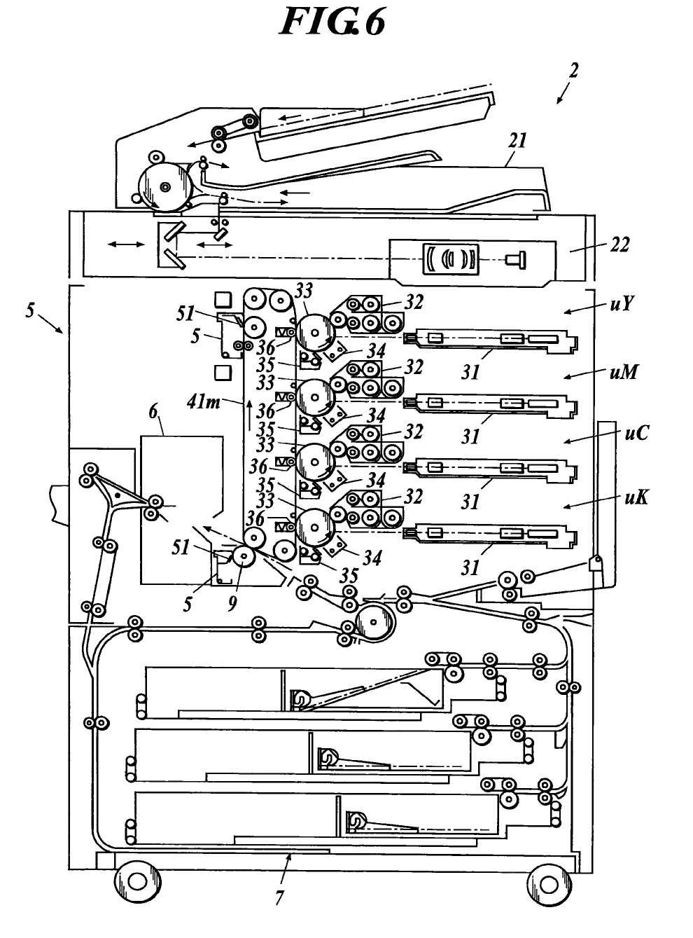

FIG. 6 shows an example of an image forming apparatus 2 comprising an intermediate transfer belt. The image forming apparatus 2 is a color image forming apparatus which is a tandem type, and forms a color image by using toners of each color of yellow (Y), magenta (M), cyan (C), and black (K). Incidentally, the basic configuration of the image forming apparatus 2 is the same as that of the image forming apparatus 1. Thus, the configurational section of the image forming apparatus 2 which is the same as that of the image forming apparatus 1 is allotted with the same reference number, and description is given only for the different configurational sections.

The image forming apparatus 2 comprises an image forming unit for each color, which is uY, uM, uC, and uK, thereby forms a toner image of each color on each photoconductive drum 33, respectively.

The transfer unit 4 comprises an intermediate transfer belt 41m which is provided in a state of being stretched by a plurality of supporting rollers. The intermediate transfer belt 41m is configured in the same manner as the transfer/conveying belt 41c which is described earlier with reference to FIGS. 1-3. That is to say, the intermediate transfer belt 41m comprises an elastic layer formed by a CR, and the like, as the base layer, and a coating layer formed by a urethane resin, and the like, is provided on a surface layer of the elastic layer.

Further, the transfer unit 4 comprises transfer rollers 36 each facing the respective photoconductive drum 33 of each image forming unit uY, uM, uC, and uK. The transfer roller 36 comes into contact with the photoconductive drum 33 in a state of pressing the photoconductive drum 33, through the intermediate transfer belt 41m, so as to transfer the toner image formed on the photoconductive drum 33 to the intermediate transfer belt 41m. The timing of the transfer of the toner image is measured so that the toner image of each color is transferred to the same position, thereby the toner image of each color is superimposed with one another on the intermediate transfer belt 41m so as to form one color toner image.

A transfer roller 9 is provided at a further downstream position in the rotation direction of the intermediate transfer belt 41m than the transfer position of each image forming unit uY, uM, uC, and uK. The transfer roller 9 is provided so as to face one of the supporting rollers of the intermediate transfer belt 41m, through the intermediate transfer belt 41m. The color toner image formed on the intermediate belt 41m is transferred onto the sheet which is conveyed from the feeding unit 7, by a nip pressure of the transfer roller 9 and of the intermediate transfer belt 41m. The sheet is conveyed to the fixing device 6 as it is, so as to be performed with the fixing processing, thus is discharged onto a tray which is provided in an external section of the image forming apparatus 2.

As shown in FIG. 6, a cleaning device 5 for the intermediate transfer belt 41m is provided at a further downstream position in the rotation direction of the intermediate transfer belt 41m than the transfer roller 9. The blade 51 of the cleaning device 5 is in contact with the intermediate transfer belt 41m, and is provided so as to face one of the supporting rollers of the intermediate transfer belt 41m, through the intermediate transfer belt 41m. The blade flection can be prevented in the same manner as in the case of the transfer/conveying belt 41c, by configuring the intermediate transfer belt 41m so that the stiffness (JIS-A) thereof is larger than that of the blade 51 of the cleaning device 5, in the temperature range which is no higher than the glass transition temperature of the toner housed in the developing device 32. Incidentally, the stiffness is defined as the stiffness of a portion at which the intermediate transfer belt 41m is in contact with the blade 51.

Further, as shown in FIG. 6, in a case where the cleaning device 5 to remove the toner remaining in the transfer roller 9 is provided adjacently to the transfer roller 9, not only the intermediate transfer belt 41m, but also the transfer roller 9 can be configured as follows. That is, the stiffness of the transfer roller 9 (the stiffness (JIS-A) of a portion at which the transfer roller 9 is in contact with the blade 51) may be configured to be larger than the stiffness of the blade 51, in the temperature range which is no higher than the glass transition temperature of the toner housed in the developing device 32. Thereby, the blade flection can be prevented also in the cleaning device 5 of the transfer roller 9. Incidentally, the transfer roller 9 also comprises an elastic layer, and a coating layer as the surface layer thereof is provided. As the elastic layer, a solid rubber, a sponge rubber (which is made by being foamed), and the like, can be named. Further, as the coating layer, a urethane resin containing fluorine, and the like, can be named.

In the following, the embodiment of the present invention is described in detail by citing examples, however, the present invention is not limited to the cited examples.

An evaluation is performed as to whether the blade flection is generated or not, when the cleaning of the transfer/conveying belt is performed, depending on the following combinations of the blade and the transfer/conveying belts.

### <Evaluation Method>

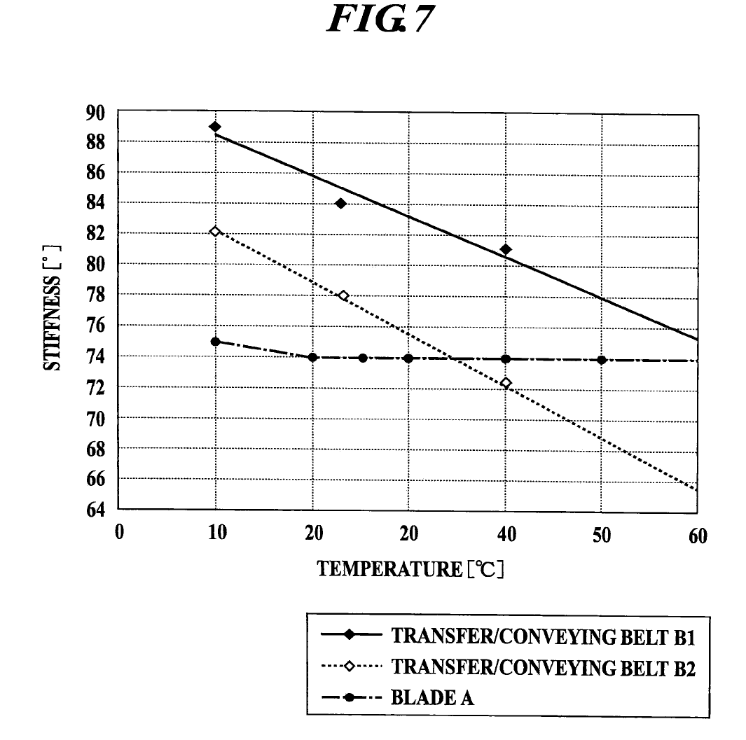

A blade A comprising the stiffness-temperature characteristics shown in FIG. 7, and transfer/conveying belts B1, B2 are prepared. An evaluation is performed in a state where the combination of the blade A and the transfer/conveying belt B1 is an example, and the combination of the blade A and the transfer/conveying belt B2 is a comparative example. The blade A is configured by a urethane rubber. Further, the elastic layer of the transfer/conveying belt B1 is configured by a mixture of a CR and a white carbon, and the elastic layer of the transfer/conveying belt B2 is configured only by a CR. Further, the coating layer is configured by a urethane resin containing fluorine in both cases, and the thickness thereof is 5 μm.

The stiffness-temperature characteristics shown in FIG. 7 are obtained as follows. That is, the glass transition temperature of the toner to be used is 60° C., and the temperature is changed in a temperature range of 10-60° C. The stiffness of the blade A and the transfer/conveying belts B1, B2 is measured at respective temperatures of 10° C., 23° C., 400C, and 60° C., and the approximation line at respective measurement points is obtained, so as to obtain the stiffness-temperature characteristics. The measurement method of the stiffness is in accordance with JIS-A, however, because the thickness of the transfer/conveying belts B1, B2 is small, the measurement is performed by using H-12 Micro Hardness Tester manufactured by Wallas corporation.

As shown in FIG. 7, the stiffness of the transfer/conveying belt B1 is constantly larger than that of the blade A in the temperature range which is no higher than 60° C. which is the glass transition temperature of the toner. The stiffness of the blade A is 74°, that of the transfer/conveying belt B1 is 78°, and that of the transfer/conveying belt B2 is 85°, at 23° C. The stiffness of the blade A is 74°, that of the transfer/conveying belt B1 is 75°, and that of the transfer/conveying belt B2 is 66°, at 60° C. On the other hand, the stiffness of the transfer belt B2 is larger than that of the blade A in the vicinity of the room temperature (which is approximately 25° C.), however, the stiffness thereof decreases as the temperature rises, and the stiffness thereof becomes smaller than that of the blade A from approximately 35° C.

A monochrome image forming apparatus as shown in FIG. 1 is configured by the combination of the above described blade A and the transfer/conveying belt B1, and by the combination of the blade A and the transfer/conveying belt B2, thus whether the blade flection is generated or not by performing the cleaning is visually confirmed. The cleaning is performed in an initial state in which the image forming apparatus is not in operation, and in an operational state in which the image forming apparatus is in operation, both at a certain environment temperature, thus an internal temperature in each operational state is measured. The internal temperature is defined as the temperature in the vicinity of the cleaning device in which the blade A is provided. Further, the internal temperature in the operational state is a temperature which is measured after a continuous printing of 15,000-20,000 sheets (which lasts for approximately 2-3 hours).

### <Evaluation Results>

The following table 1 shows the evaluation results of the blade flection.

TABLE 1

| | | | EXISTENCE/NON- | |
|---|---|---|---|---|
| | | | EXISTENCE OF BLADE | |
| | | | FLECTION | |
| | | | | COMPARATIVE |
| | | | EXAMPLE | EXAMPLE |
| | | | (BLADE A + | (BLADE A + |
| | | | TRANSFER/ | TRANSFER/ |
| ENVIRONMENT | OPERATIONAL | INTERNAL | CONVEYING | CONVEYING |
| TEMPERATURE | STATE | TEMPERATURE | BELT B1) | BELT B2) |
| 10° C. | INITIAL STATE | 10° C. | NON- | NON- |
| | | | EXISTENT | EXISTENT |
| 20° C. | INITIAL STATE | 20° C. | NON- | NON- |
| | | | EXISTENT | EXISTENT |
| | OPERATIONAL | 35° C. | NON- | EXISTENT |
| | STATE | | EXISTENT | |
| 30° C. | INITIAL STATE | 30° C. | NON- | NON- |
| | | | EXISTENT | EXISTENT |
| | OPERATIONAL | 45° C. | NON- | EXISTENT |
| | STATE | | EXISTENT | |
| | OPERATIONAL | 55° C. | NON- | EXISTENT |
| | STATE (WHEN | | EXISTENT | |
| | COOLING IS | | | |
| | INSUFFICIENT) | | | |

Incidentally, the internal temperature in the operational state in Table 1 is a temperature measured in a case where the cooling function to suppress the temperature rise in the image forming apparatus functions normally, however, the temperature at the internal temperature of 55° C. is a temperature measured in an exclusive case where the cooling is insufficient.

As shown in Table 1, the internal temperature is the same as the environment temperature at the initial state where the image forming apparatus is not in operation, however, the internal temperature rises to a temperature higher than the environment temperature by no less than 10° C., when the image forming apparatus is in operation. Among these internal temperatures, the blade flection is not generated under a certain temperature which is no higher than the glass transition temperature of the toner which is 60° C., in a case where the combination of the blade A and the transfer/conveying belt B1 according to the example is applied. This is considered to be because the stiffness of the transfer/conveying belt B1 is larger than that of the blade A under the certain temperature, thus the blade A is not trapped by the movement of the transfer/conveying belt B1.

On the other hand, in the comparative example, the blade flection is generated when the temperature rises to a temperature higher than 35° C., in which the relationship of the stiffness is reversed.

Incidentally, an evaluation in the same manner is performed for the intermediate transfer belt and for the transfer roller in substitution for the transfer/conveying belt, and the evaluation results were obtained in the same manner as in the case of the transfer/conveying belt, in either of the cases.

According to a first aspect of the embodiment of the present invention, there is provided an image forming apparatus comprising:

a developing device to house a toner and to form a toner image on an image carrier;

a transfer belt to transfer the toner image formed on the image carrier to a sheet, the transfer belt comprising an elastic layer; and

a blade to remove the toner remaining on the transfer belt after the toner image has been transferred, the blade being in contact with the transfer belt, wherein

the transfer belt and the blade are configured so that a stiffness of the transfer belt is larger than a stiffness of the blade, in a temperature range which is no higher than a glass transition temperature of the toner.

According to the embodiment of the present invention, the generation of the blade flection can be prevented by decreasing the amount of depression formed on the surface of the transfer belt or of the transfer roller caused by the contacting pressure of the blade, at least in the temperature range in which the image formation using the toner is possible.

Preferably, the transfer belt further comprises a coating layer on a surface layer of the elastic layer.

Preferably, the transfer belt is a transfer/conveying belt.

Preferably, the transfer belt is an intermediate transfer belt.

According to a second aspect of the embodiment of the present invention, there is provided an image forming apparatus comprising:

a developing device to house a toner and to form a toner image on an image carrier;

a transfer roller to transfer the toner image formed on the image carrier to a sheet, the transfer roller comprising an elastic layer; and

a blade to remove the toner remaining on the transfer roller after the toner image has been transferred, the blade being in contact with the transfer roller, wherein

the transfer roller and the blade are configured so that a stiffness of the transfer roller is larger than a stiffness of the blade, in a temperature range which is no higher than a glass transition temperature of the toner.

According to the embodiment of the present invention, the generation of the blade flection can be prevented by decreasing the amount of depression formed on the surface of the transfer belt or of the transfer roller caused by the contacting pressure of the blade, at least in the temperature range in which the image formation using the toner is possible.

The present U.S. patent application claims a priority under the Paris Convention of Japanese patent application No. 2008-132650 filed on May 21, 2008, which shall be a basis of correction of an incorrect translation.

What is claimed is:

1. An image forming apparatus comprising:
a developing device to house a toner and to form a toner image on an image carrier;
a transfer belt to transfer the toner image formed on the image carrier to a sheet, the transfer belt comprising an elastic layer; and
a blade to remove the toner remaining on the transfer belt after the toner image has been transferred, the blade being in contact with the transfer belt, wherein
the transfer belt and the blade are configured so that a stiffness of the transfer belt is larger than a stiffness of the blade, in a temperature range which is no higher than a glass transition temperature of the toner.

2. The image forming apparatus of claim 1, wherein the transfer belt further comprises a coating layer on a surface layer of the elastic layer.

3. The image forming apparatus of claim 1, wherein the transfer belt is a transfer/conveying belt.

4. The image forming apparatus of claim 1, wherein the transfer belt is an intermediate transfer belt.

5. An image forming apparatus comprising:
a developing device to house a toner and to form a toner image on an image carrier;
a transfer roller to transfer the toner image formed on the image carrier to a sheet, the transfer roller comprising an elastic layer; and
a blade to remove the toner remaining on the transfer roller after the toner image has been transferred, the blade being in contact with the transfer roller, wherein
the transfer roller and the blade are configured so that a stiffness of the transfer roller is larger than a stiffness of the blade, in a temperature range which is no higher than a glass transition temperature of the toner.
